(19) United States
(12) Patent Application Publication
(10) Pub. No.: US 2020/0306715 A1
(43) Pub. Date: Oct. 1, 2020

(54) Porous polymer microspheres with optical anisotropy, method of manufacturing the same and application of the same

(71) Applicant: Smart Liquid Crystal Technologies Co., Ltd., Suzhou (CN)

(72) Inventors: Rui Wang, Suzhou (CN); Nicholas L. Abbott, Madison, WI (US); Ang Li, Suzhou (CN)

(73) Assignee: Smart Liquid Crystal Technologies Co., Ltd., Suzhou (CN)

(21) Appl. No.: 16/769,759

(22) PCT Filed: Dec. 20, 2018
(86) PCT No.: PCT/CN2018/122320

§ 371 Date: Jun. 4, 2020

(30) Foreign Application Priority Data
Dec. 25, 2017 (CN) 201711420820.6

(51) Int. Cl. B01J 13/04; B01J 20/285; B01J 20/26; B01J 20/30; C09K 19/12; C09K 19/20

(52) U.S. Cl. CPC B01J 13/043; B01J 20/285; C09K 19/20; B01J 20/3057; C09K 19/12; B01J 20/261

(57) ABSTRACT

Porous polymer microsphere having radial optical anisotropy and diverse swelling states when dispersed in different solvents, which have ability to well swell the porous microspheres. A method for preparing the porous polymer microspheres, including: forming a homogeneous liquid crystal mixture; dispersing the liquid crystal mixture into a continuous phase to form a emulsion of liquid crystal droplets; polymerizing the at least one reactive liquid crystal to form intermediate microspheres; removing the at least one non-reactive liquid crystal compound to form the porous polymer microspheres; separating, washing and dispersing or drying the porous polymer microspheres. The polymer microspheres can be used as the stationary phase in chromatograph separation, improving separation efficiency and column packing efficiency.

### FIELD OF THE INVENTION

The present invention relates to porous polymer microspheres. More particularly, the invention relates to porous polymer microspheres with optical anisotropy, method of manufacturing the same and application of the same.

### BACKGROUND OF THE INVENTION

Microspheres, comprising inorganic or organic macromolecular materials, may be of sizes of nanometers to micrometers and of spherical shapes or other similar shapes with various interior structures, including solid structures, hollow structures, porous structures, core-shell structures, yolk structures and other structures. Moreover, organic polymer microspheres can be mainly divided into natural polymer microspheres and synthetic polymer microspheres. Due to their special sizes, diverse interior structures and peculiar functions, polymer microspheres are widely applied in biochemical separation, reaction catalysis, biochemical detection, electronic information, drug release or other fields. One of most important applications is chromatography in biochemical separation.

Widely used to separate and purify various materials: from small molecules to macromolecules, or from synthetic polymers to natural materials, chromatography has become an effective separation method. In the method, the stationary phase is usually filled into the column by a packing method, and then the mobile phase containing a product to be separated is introduced into the column. Depending on the interaction between the product and the stationary phase, the time it takes for the product flowing out of the column with mobile phase is different, thus achieving the purpose of separation. The materials constituting the stationary phase can be of organic and inorganic, where organic material is mainly composed of natural sugars and polymers and inorganic material is mainly silica. Among the organic packing materials, polymers become very important options in chromatography, due to their excellent chemical and physical stability and the ability to achieve various separation modes by introducing different functional groups and different structures.

In order to increase producitivy and reduce cost, polymer microparticles of uniform particles size are commonly used in the industry as chromatography stationary phase. There are many methods for preparing polymer microspheres, such as emulsion polymerization, dispersion polymerization, single coacervation, and complex coacervation. The current production process has been able to prepare cross-linked polymer microspheres with a relatively uniform particle size and a certain mechanical strength, as disclosed in Chinese patent application CN106633168A and patent CN103374143B. However because of their irregular interior pores, when the polymer microspheres are applied to the chromatography process, the mobile phase may have an unfavorable diffusion effect, and further the separation result may be affected. How to control the interior molecular structure, interior pore structure and orientation has become one of the research hotspots to improve the performance of stationary phase in recent years.

Therefore, there remains a need for providing porous polymer microspheres, which have a uniform and controllable size, a regular interior structure, and a pore distribution as well as an easily operated manufacture method, to improve separation efficiency of the chromatographic column and thus save separation time.

### SUMMARY OF THE INVENTION

In order to fulfill the above mentioned need, one objective of the present invention is to provide porous polymer microspheres having radial optical anisotropy, wherein the porous polymer microspheres have diverse swelling states when dispersed in different solvent which have ability to well swell the porous polymer microspheres.

In some preferred embodiments, the solvent is THF, toluene or ethanol.

In some preferred embodiments, the average particle size of the porous polymer microspheres in ethanol is 1 μm-150 μm.

In some embodiments, the swelling degree of the porous polymer microspheres in THF is 1.0-7.0.

Another objective of the present invention is to provide a method for preparing the porous polymer microspheres, comprising the following steps: (I) forming a homogeneous liquid crystal mixture, wherein the liquid crystal mixture comprises at least one reactive liquid crystal compound, at least one non-reactive liquid crystal compound and at least one polymerization initiator; (II) dispersing the liquid crystal mixture into a continuous phase containing liquid-crystal-configuration-adjusting agent through a membrane emulsification device to form a emulsion of liquid crystal droplets, wherein the liquid-crystal-configuration-adjusting agent align liquid crystal molecules inside the liquid crystal droplets along the radial direction; (III) polymerizing the at least one reactive liquid crystal compound to form intermediate microspheres; (IV) removing the at least one non-reactive liquid crystal compound from the intermediate microspheres to form the porous polymer microspheres; (V) separating, washing and dispersing or drying the porous polymer microspheres.

In some preferred embodiments, the way of polymerizing includes photo polymerization, thermal polymerization and radiation polymerization. In more preferred embodiments, the way of polymerizing is photo polymerization.

In some preferred embodiment, the at least one reactive liquid crystal compound is 5%-50% by weight of the liquid crystal mixture.

In some preferred embodiments, the at least one non-reactive liquid crystal compound is nematic liquid crystal.

In some preferred embodiments, the liquid-crystal-configuration-adjusting agent is SDS, NaI or NaClO₄. In more preferred embodiments, the liquid-crystal-configuration-adjusting agent is SDS, and the concentration of SDS in the continuous phase is 1 mM to 200 mM.

In some preferred embodiments, the continuous phase is water or a water-miscible system.

Another objective of the present invention is to provide an application of the porous polymer microspheres as the stationary phase in chromatograph separation.

The present invention utilizes a liquid-crystal-assisted template polymerization method to prepare porous polymer microparticles with controlled sizes. Because of the porous structure and the swell property in solutions, the polymer microspheres may be used as the stationary phase of chromatograph separation, improving both separation efficiency and packing efficiency of the column. Meanwhile, the porous polymer microparticles have radial optical anisotropy, indicating their ordered interior structures. Since the space order of polymer molecules will involve in the separation process, the porous polymer microspheres as the stationary phase provide a better separation effect for a mixture of components with similar boiling point and polarities but different structures, but cause no adverse diffusion effects on the mobile phase.

### BRIEF DESCRIPTION OF THE DRAWINGS

These and other features and advantages of the present invention will be better understood by reference to the following detailed description of an illustrative embodiment of the present disclosure when read in conjunction with the accompanying drawings, wherein:

FIG. 1 is a schematic, illustrative view of exterior and interior structures of porous polymer microspheres prepared according to an embodiment of the present invention.

FIG. 2 is a schematic, illustrative view of the molecule structure of the reactive liquid crystal.

FIG. 3 is a polarizing microscope image (cross polars) of a polymer microsphere prepared according to an embodiment of the present invention,

FIG. 4 is a schematic, illustrative view of a membrane emulsification technology for preparing liquid crystal droplets.

FIG. 5 is a schematic, illustrative view of the interior structure of a liquid crystal droplet with radial configuration.

FIG. 6 is a schematic, illustrative view of the structure of a polymer microsphere at different phases during the liquid-crystal-assisted template polymerization method: (a) before polymerization, (b) after polymerization and (c) after removing the template.

FIG. 7 is (a) parallel polars (b) cross polars microscope images of liquid crystal droplets prepared according to an embodiment of the present invention (same scale bar for all images).

FIG. 8 shows polarizing microscope images of liquid crystal droplets prepared by using different liquid-crystal-configuration-adjusting agents: (a) NaI and (b) NaClO₄ (same scale bar for all images).

FIG. 9 is polarizing microscope images of polymer microspheres in (a) dry condition, (b) THF, (c) toluene and (d) ethanol (same scale bar for all images).

FIG. 10 is a SEM image of exterior of a polymer microsphere prepared to an embodiment of the present invention.

FIG. 11 is polarizing microscope images of porous polymer microspheres in ethanol (same scale bar for all images).

FIG. 12 is a SEM image of interior structure of a polymer microsphere in dry condition (same scale bar for all images).

FIG. 13 is polarizing microscope images of polymer microspheres in (a) dry condition, (b) THF, (c) toluene and (d) ethanol (same scale bar for all images).

FIG. 14 is polarizing microscope images of polymer microspheres in (a) dry condition and (b) ethanol (same scale bar for all images).

FIG. 15 is polarizing microscope images of polymer microspheres in toluene and (d) ethanol (same scale bar for all images).

FIG. 16 is polarizing microscope images of polymer microspheres in toluene and (d) ethanol (same scale bar for all images).

### DETAILED DESCRIPTION OF THE INVENTION

The following description of the disclosed embodiments is provided in detail to enable any person skilled in the art to fully understand the present invention. However, it will be apparent to those skilled in the art to readily make or use the present invention without these specific details. In other examples, well-known structures and devices are shown in the block diagram. In this regard, the description of the different illustrative exemplary embodiments presented herein are for the purpose of illustration and description and are not intended to be exhaustive or limited to the inventive concept. Accordingly, the scope of the invention is not to be limited by the specific embodiments described above, and is subject only to the scope of the appended claims.

Abbreviations used in the present invention are listed below:

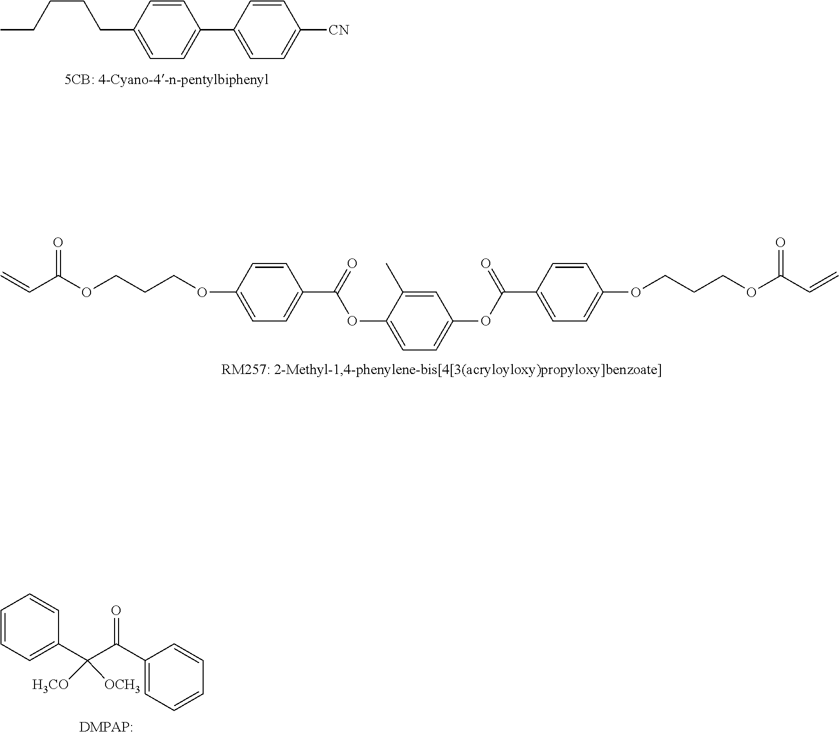

SPG membrane: Shirasu Porous Glass membrane

SDS: sodium dodecyl sulfate

THF: tetrahydrofuran.

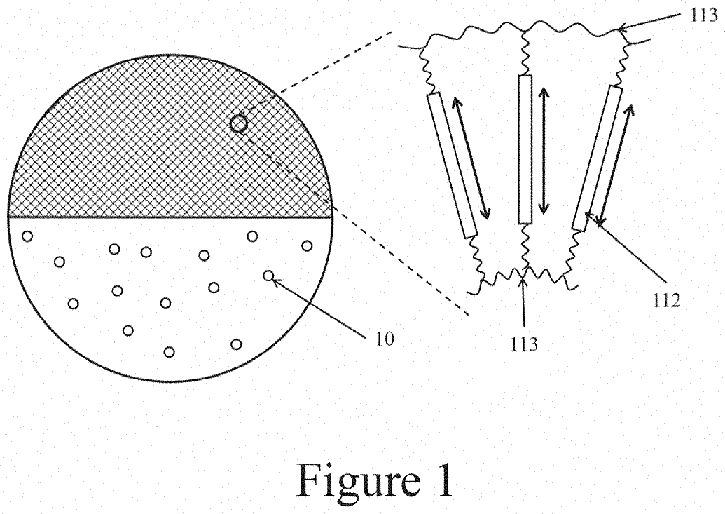

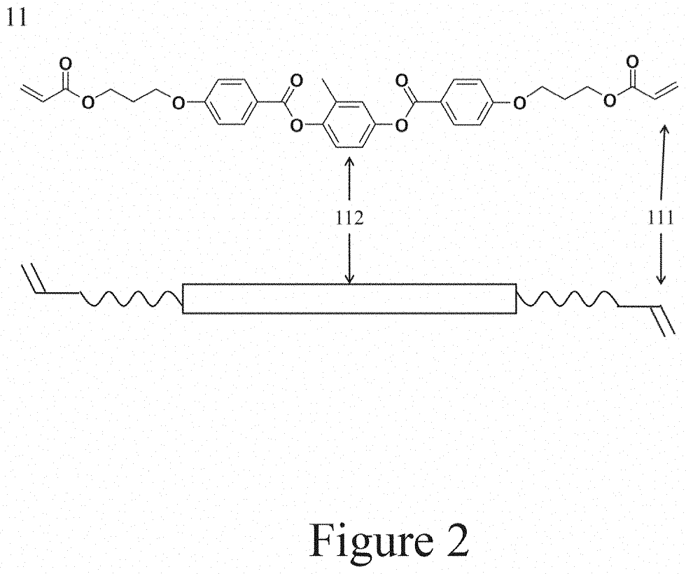

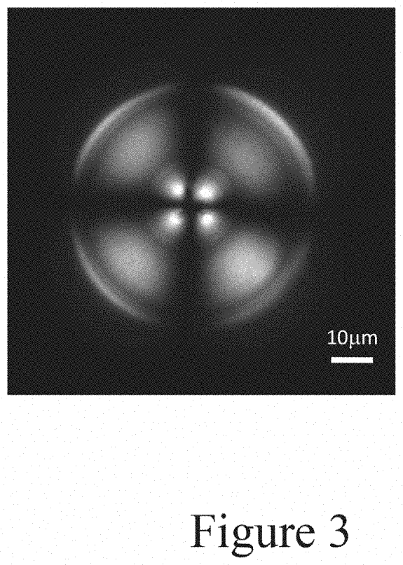

Referring first to FIG. 1, it shows the exterior (lower half part) and interior structure (upper half part) of the porous polymer microspheres with radial optical anisotropy. The size of micropores 10 distributed inside and outside of polymer microspheres can range from 20 nm to 200 nm. The polymer microspheres present gel properties and have different swelling states in different solvents, where the swelling degree (the volume of microsphere in the solvent/the volume of dry microsphere) can reach 7.0. The particle size of the polymer microspheres (in ethanol) can be precisely controlled from 1 μm to 150 μm. The polymer microspheres are formed by polymerization of the reactive liquid crystals 11, and the polymerization methods include thermal polymerization, photo polymerization, and radiation polymerization. As shown in FIG. 2, the reactive liquid crystals 11 (such as RM257 in the drawing) include a polymerizable portion 111 and a mesogen portion 112. Inside the polymer microspheres, the mesogen portion 112 of the reactive liquid crystals 11 orderly align along the radial direction (the direction of the double-headed arrow in FIG. 1). Correspondingly, the polymer molecular chain 113 formed by polymerization or crosslink of the polymerizable portion 111 of the reactive liquid crystals 11 are always perpendicular to the radius of the polymer microspheres. Due to this radial symmetry property, the polymer microspheres have a radial optical anisotropy, exhibiting a typical Maltese black cross image under a crossed polarized microscope, as shown in FIG. 3.

Porous polymer microspheres with a radial optical anisotropy can be prepared by a liquid-crystal-assisted template polymerization method, including the following steps: First, at least one reactive liquid crystal, at least one non-reactive liquid crystal, and at least one polymerization initiator are mixed in a certain ratio to form a uniform liquid crystal mixture. The reactive liquid crystal compounds contain polymerizable groups and can be further polymerized in the presence of polymerization initiators, such as acrylate type liquid crystals (RM257), methacrylate type liquid crystals (HCM062), allyl type liquid crystals (HCM126) and so on. The non-reactive liquid crystal compounds do not have polymerizable groups to further polymerize. The non-reactive liquid crystal may be a nematic liquid crystal, a cholesteric liquid crystal, a smectic liquid crystal, and other liquid crystals without polymerizable groups. The mass ratio of the reactive liquid crystal compound over the liquid crystal mixture varies from 0.05 to 0.50.

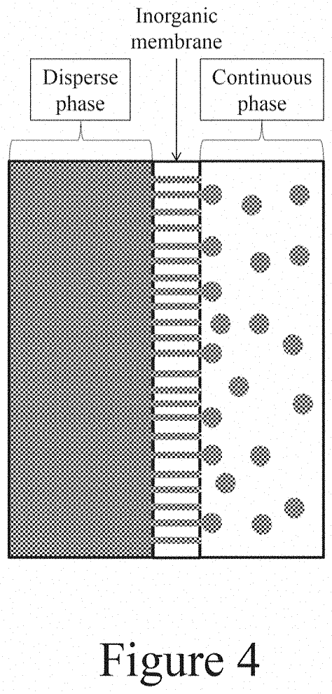

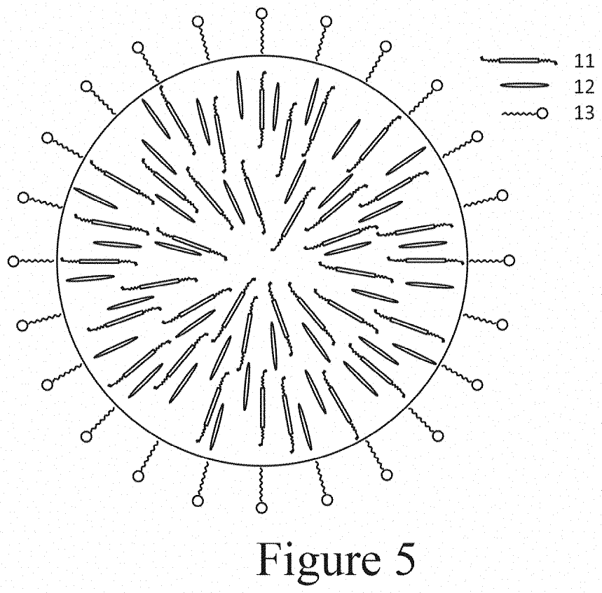

After that, the liquid crystal mixture is passed through a membrane emulsification device into a continuous phase to form monodisperse liquid crystal droplets. The continuous phase can be water. The principle of the membrane emulsifier device is shown in FIG. 4, which mainly uses a membrane-based dispersion technique to achieve the preparation of monodisperse liquid crystal droplets. The liquid crystal mixture as a dispersed phase is slowly passed through a micro porous inorganic membrane, and the liquid crystal mixture is extruded from the micropores of the inorganic membrane to form liquid crystal droplets dispersed into the continuous phase, thereby forming a dispersing system with the liquid crystal droplets as the disperse phase. The size of the liquid crystal droplets can be controlled by the pore size of the inorganic membrane to finally control the particle size of the polymer microspheres. In the following examples, we chose a membrane emulsification device using a micro porous SPG membrane to precisely control the particle size of the liquid crystal droplets, which can be adjusted from 0.1 μm to 150 μm. The continuous phase contains a liquid-crystal-configuration-adjusting agent 13, aligning the liquid crystal molecules (including the reactive liquid crystals 11 and the non-reactive liquid crystals 12) in the liquid crystal droplets along the radial direction to form a radial configuration, as shown in FIG. 5. The liquid-crystal-configuration-adjusting agent includes SDS, NaI, and NaClO₄, wherein the concentration of SDS is from 1 mM to 200 mM.

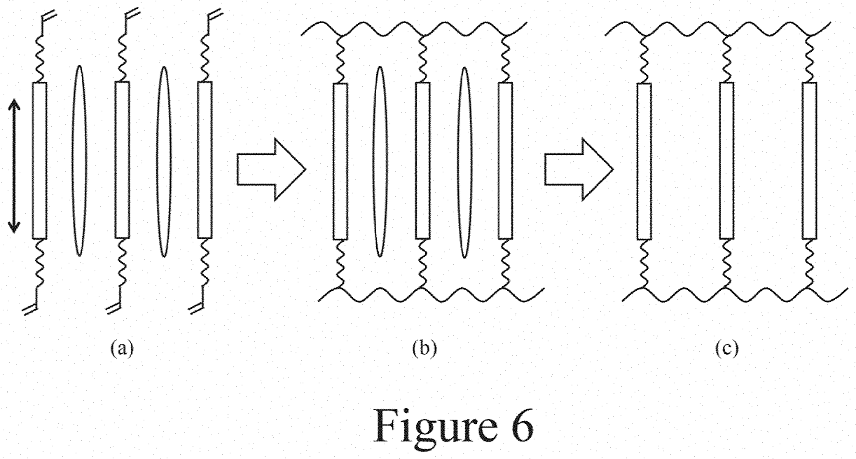

Next, the reactive liquid crystals 11 in the liquid crystal droplets are polymerized to form intermediate microspheres containing the unreacted non-reactive liquid crystals 12. As shown in FIG. 6(a), before polymerization, liquid crystal molecules are aligned in the radial direction of the liquid crystal droplets (the direction of the double-headed arrow in FIG. 6) due to the presence of the liquid-crystal-configuration-adjusting agent, where the mesogen portion of the reactive liquid crystals 11 is located at the side chain portion of polymer. After polymerization, the polymer main chain is perpendicular to the radial direction of the intermediate microspheres, as shown in FIG. 6(b). The polymerization method may be photo polymerization, thermal polymerization or radiation polymerization. In the following examples, photo polymerization is preferably.

Then porous polymer microparticles are further formed by removing the unreacted non-reactive liquid crystals. As shown in FIG. 6(c), since the non-reactive liquid crystals 12 do not participate in the polymerization reaction, removing of the non-reactive liquid crystals forms micropores inside the polymer microspheres, whose distribution is influenced by the alignment of the liquid crystal molecules and tends to be along the radial direction of the polymer microspheres, thus forming an ordered interior micro porous structure.

Finally, the polymer microspheres are separated, washed and dispersed/dried. Because the polymer microspheres have different swelling states in different solvents, the polymer microspheres at dry and in solvents have different particle sizes and morphologies. In the following examples, the polymer microspheres in ethanol have a particle size from 1 μm to 150 μm.

The dried polymer microparticles can be applied in biochemical separation as the stationary phase of chromatography. Chromatography is usually carried out by a column operation, where the polymer microparticles are packed in the column and a mobile phase containing different components is passed through the column. Due to the porous structure, the solvent-dependent swelling degree and the special and regular interior structure, the polymer microparticles, as the stationary phase, have different interaction with various substances as well as different combination levels, achieving the purpose of substance separation.

In the present invention, the ratios all refer to mass ratios, unless otherwise indicated.

### Example 1: Preparation of Liquid Crystal Droplets with Radial Optical Anisotropy

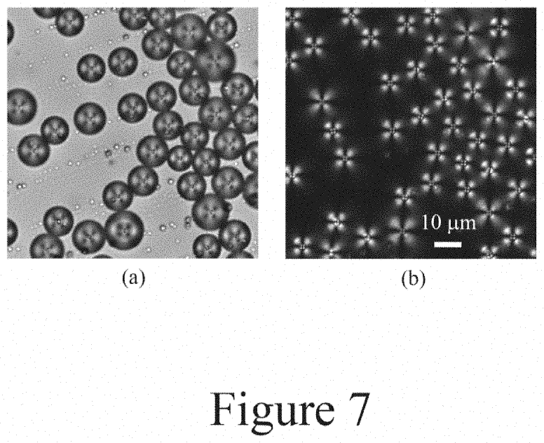

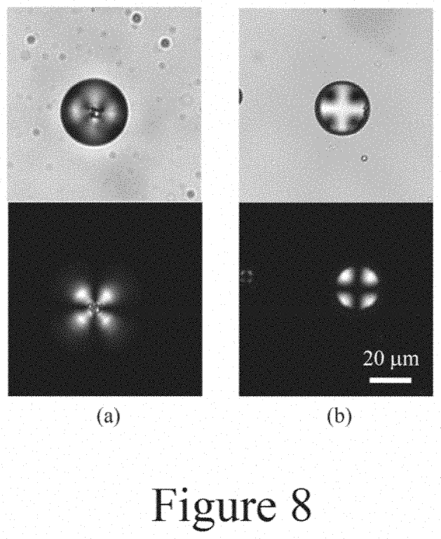

First, 7.9 g of 5CB (non-reactive liquid crystal) compound 5CB, 2 g of RM257 (reactive liquid crystal), and 0.1 g of DMPAP (photo polymerization initiator) were mixed and heated above the clearing point of the liquid crystals to form a homogeneous solution. After that, the solution was sufficiently shaken to be uniformly blended and then slowly cooled to room temperature, forming a liquid crystal mixture. Since DMPAP is sensitive to light, the solution must be placed in dark during the cooling process. 100 mg of the above uniform liquid crystal mixture was slowly and smoothly passed through a membrane emulsifier device with a membrane pore diameter of 2.8 μm under a pressure of 0.030 MPa, and dispersed into 275 ml of mM SDS aqueous solution (water is the continuous phase, SDS is the liquid-crystal-configuration-adjusting agent). The prepared liquid crystal droplets are uniform in size which is averagely 10 μm (as shown in FIG. 7(a)) and have a radial optical anisotropy (as shown in FIG. 7(b)), indicating that the liquid crystal molecules in the prepared liquid crystal droplets are aligned with the radial configuration. The liquid-crystal-configuration-adjusting agent may also be NaClO₄ (as shown in FIG. 8(a)) or NaI (as shown in FIG. 8(b)), where the liquid crystal droplets are all shown to have radial optical anisotropy, that is, the internal liquid crystal molecules are aligned in a radial configuration.

### Example 2

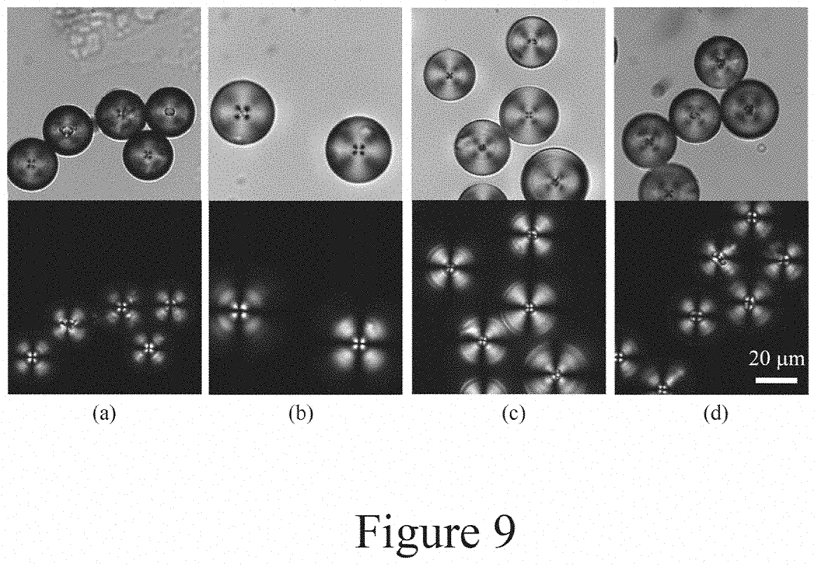

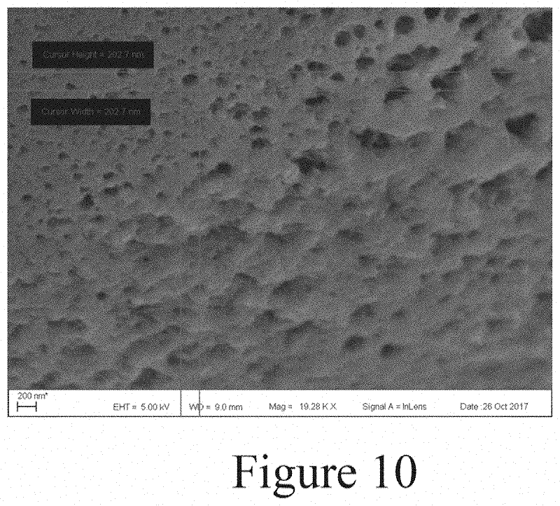

A liquid crystal mixture (40% RM257, 1% DMPAP) was prepared as example 1. Then 10 g of the liquid crystal mixture was slowly and smoothly passed through a membrane emulsifier device with a membrane pore size of 10 μm under a pressure of 0.030 MPa, and dispersed in 275 mL of 2 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 9, the polymer microspheres have a radial optical anisotropy (Maltese Black Cross) both in (a) dry conditions and solution systems (b: THF, c: toluene, d: ethanol). It indicates that after polymerization of RM257, the polymerization main chain is perpendicular to the radial direction, and its side chains as the mesogen group are aligned in the radial direction, that is, the prepared polymer microspheres have a regular internal structure of radial configuration. Meanwhile, the polymer microspheres all show a uniform shrinkage phenomenon when dried and a swelling phenomenon in a good solvent, indicating that the polymer microspheres have a micro porous structure inside. The swelling degrees of the polymer microspheres are different in different solvents (THF: 2.10, toluene: 1.73, ethanol: 1.36), and the average particle size in ethanol was 27.7 μm. As shown in FIG. 10, the SEM image of the dried polymer microspheres shows that the polymer microspheres have a porous surface with pore sizes ranging from 20 nm to 200 nm.

### Example 3

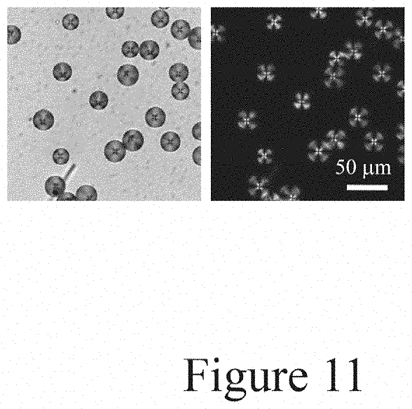

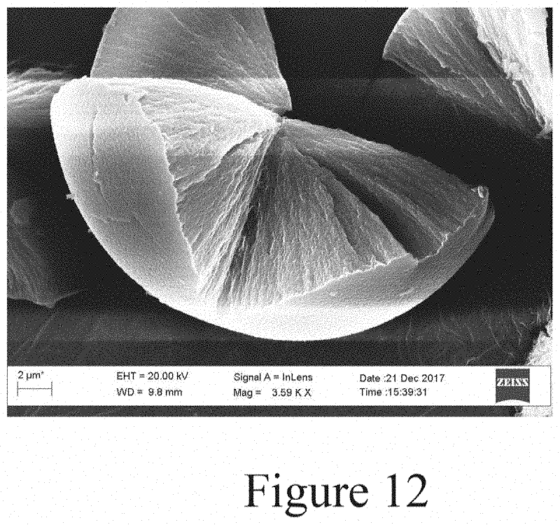

A liquid crystal mixture (20% RM257, 1% DMPAP) was prepared as example 1. Then 10 g of the liquid crystal mixture was slowly and smoothly passed through a membrane emulsifier device with a membrane pore size of 10 μm under a pressure of 0.030 MPa, and dispersed in 275 mL of 78 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 11, the polymer microspheres have a radial optical anisotropy (Maltese Black Cross) in ethanol. It indicates that after polymerization of RM257, the polymerization main chain is perpendicular to the radial direction, and its side chains as the mesogen group are aligned in the radial direction, that is, the prepared polymer microspheres have a regular internal structure of radial configuration. As shown in FIG. 12, the SEM image of the dried polymer microspheres shows that the polymer microspheres have an inner regular structure along the radial direction. However due to shrinkage of the dried polymer microspheres, the interior pores cannot be realized in the SEM image. The average particle size of the prepared polymer microspheres in ethanol was 25 μm.

### Example 4

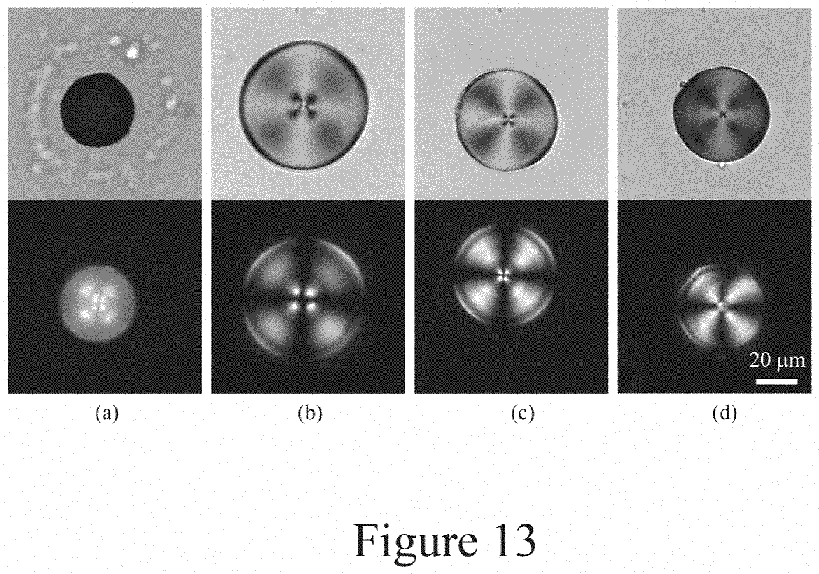

A liquid crystal mixture (20% RM257, 1% DMPAP) was prepared as example 1. Then 10 g of the liquid crystal mixture was slowly and smoothly passed through a membrane emulsifier device with a membrane pore size of 20 μm under a pressure of 0.030 MPa, and dispersed in 275 mL of 2 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 13, the polymer microspheres have a radial optical anisotropy (Maltese Black Cross) both in (a) dry conditions and solution systems (b: THF, c: toluene, d: ethanol). It indicates that after polymerization of RM257, the polymerization main chain is perpendicular to the radial direction, and its side chains as the mesogen group are aligned in the radial direction, that is, the prepared polymer microspheres have a regular internal structure of radial configuration. Meanwhile, the polymer microspheres all show a uniform shrinkage phenomenon when dried and a swelling phenomenon in a good solvent, indicating that the polymer microspheres have a micro porous structure inside. The swelling degrees of the polymer microspheres are different in different solvents (THF: 5.34, toluene: 4.50, ethanol: 4.24), and the average particle size in ethanol was 40 μm. Comparing to the polymer microspheres in example 2, the swelling degrees substantially increase, further indicating the polymer microspheres in this example have larger interior pores.

### Example 5

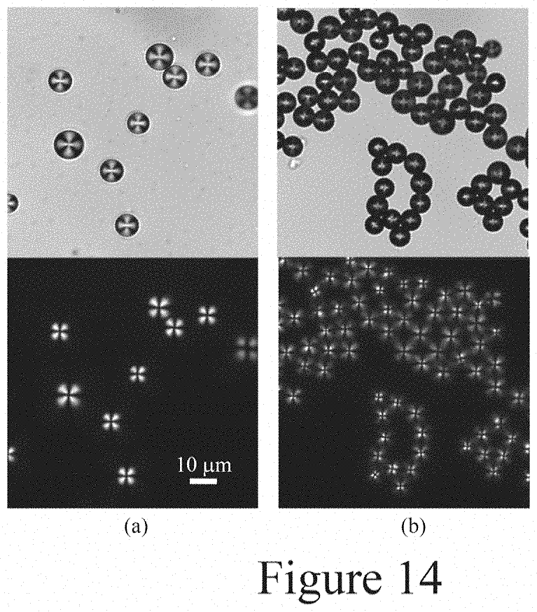

A liquid crystal mixture (20% RM257, 1% DMPAP) was prepared as example 1. Then 10 g of the liquid crystal mixture was slowly and smoothly passed through a membrane emulsifier device with a membrane pore size of 2.8 μm under a pressure of 0.030 MPa, and dispersed in 275 mL of 160 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 14, the polymer microspheres have a radial optical anisotropy (Maltese Black Cross) both in (a) dry conditions and solution systems (b: ethanol). It indicates that after polymerization of RM257, the polymerization main chain is perpendicular to the radial direction, and its side chains as the mesogen group are aligned in the radial direction, that is, the prepared polymer microspheres have a regular internal structure of radial configuration. The average particle size of the polymer microspheres in ethanol was 10 μm.

### Example 6

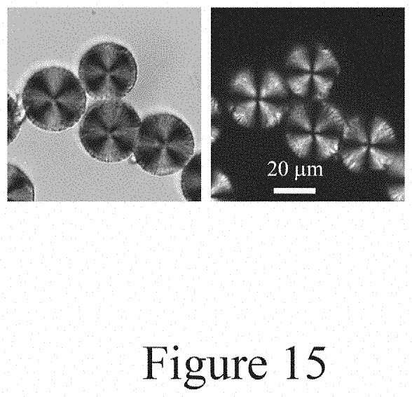

A liquid crystal mixture (10% RM257, 1% DMPAP) was prepared as example 1. Then 10 g of the liquid crystal mixture was slowly and smoothly passed through a membrane emulsifier device with a membrane pore size of 10 μm under a pressure of 0.030 MPa, and dispersed in 275 mL of 2 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 15, the polymer microspheres have a radial optical anisotropy (Maltese Black Cross) in ethanol. It indicates that after polymerization of RM257, the polymerization main chain is perpendicular to the radial direction, and its side chains as the mesogen group are aligned in the radial direction, that is, the prepared polymer microspheres have a regular internal structure of radial configuration. The average particle size of the polymer microspheres in ethanol was 29 μm.

### Example 7

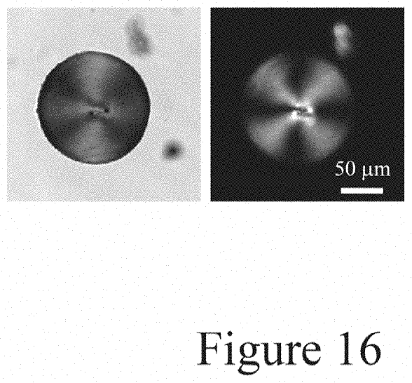

A liquid crystal mixture (20% RM257, 1% DMPAP) was prepared as example 1. Then 10 g of the liquid crystal mixture was slowly and smoothly passed through a membrane emulsifier device with a membrane pore size of 50 μm under a pressure of 0.030 MPa, and dispersed in 275 mL of 2 mM SDS aqueous solution (water is the continuous phase, SDS is the liquid-crystal-configuration-adjusting agent) to form an emulsion containing liquid crystal droplets with a uniform size and a radial configuration. After that, the emulsion was placed under a UV light source to process polymerization. The radiation intensity was 2.5 mW/cm², and the time was 30 minutes. The system needs to be constantly stirred during the polymerization. After the polymerization, the reaction solution was washed with ethanol and then centrifuged (8000 rpm, 10 minutes) to remove the supernatant. After repeating the washing and centrifugation three times, the ethanol was removed to obtain polymer microspheres without 5CB, and then the polymer microspheres were dispersed in different solvents. The polymer microspheres may also be dried for further applications. As shown in FIG. 16, the polymer microspheres have a radial optical anisotropy (Maltese Black Cross) in ethanol. It indicates that after polymerization of RM257, the polymerization main chain is perpendicular to the radial direction, and its side chains as the mesogen group are aligned in the radial direction, that is, the prepared polymer microspheres have a regular internal structure of radial configuration. The average particle size of the polymer microspheres in ethanol was 120 μm.

In addition, for the purpose of concise illustration, the drawings herein are described in terms of a substantially planar form. However, it should be understood by those skilled in the art that the rearview mirror (and all of its functional layers) of the present invention may also include concave and convex curved surfaces, such as cylinders, spheres, ellipsoids, parabolas, or their combination. In addition, it will be appreciated by those skilled in the art that the rearview mirror of the present invention may also be applied to a combined rearview mirror system which has two or more different mirrors with different reflection directions or curvature characteristics.

While several particular exemplary embodiments have been described above in detail, the disclosed embodiments are considered illustrative rather than limiting. Those skilled in the art will readily realize that alternatives, modifications, variations, improvements, and substantial equivalents are possible without substantially departing from the novelty spirits or scope of the present disclosure. Thus, all such alternatives, modifications, variations, improvements, and substantial equivalents are intended to be embraced within the scope of the present disclosure as defined by the appended claims.

### INDUSTRIAL APPLICABILITY

The method of the present invention can be applied to the field of polymer.

1. Porous polymer microspheres, having radial optical anisotropy, wherein the porous polymer microspheres have diverse swelling states when dispersed in different solvents, and wherein the solvents have ability to well swell the porous polymer microspheres.

2. The porous polymer microspheres of claim 1, wherein the average particle size of the porous polymer microspheres in ethanol is 1 μm-150 μm.

3. The porous polymer microspheres of claim 1, wherein the swelling degree of the porous polymer microspheres in tetrahydrofuran is 1.0-7.0.

4. A method for preparing the porous polymer micro spheres, comprising:
(I) forming a homogeneous liquid crystal mixture, wherein the liquid crystal mixture comprises at least one reactive liquid crystal compound, at least one non-reactive liquid crystal compound and at least one polymerization initiator;
(II) dispersing the liquid crystal mixture into a continuous phase containing liquid-crystal-configuration-adjusting agent through a membrane emulsification device, to form a emulsion of liquid crystal droplets, wherein the liquid-crystal-configuration-adjusting agent align liquid crystal molecules inside the liquid crystal droplets along the radial direction;
(III) polymerizing the at least one reactive liquid crystal compound to form intermediate microspheres;
(IV) removing the at least one non-reactive liquid crystal compound from the intermediate microspheres to form the porous polymer microspheres; and
(V) separating, washing and dispersing or drying the porous polymer microspheres.

5. The method of claim 4, wherein the step of polymerizing includes photo polymerization, thermal polymerization, radiation polymerization, and combinations thereof.

6. The method of claim 4, wherein the at least one reactive liquid crystal compound is 5%-50% by weight of the liquid crystal mixture.

7. The method of claim 4, wherein the at least one non-reactive liquid crystal compound is nematic liquid crystal.

8. The method of claim 4, wherein the liquid-crystal-configuration-adjusting agent is sodium dodecyl sulfate.

9. The method of claim 8, wherein the concentration of sodium dodecyl sulfate in the continuous phase is 1 mM to 200 mM.

10. An application of the porous polymer microspheres comprising:
utilizing the porous polymer microspheres of claim 1 as a stationary phase in chromatograph separation.
